(19) United States
(12) Patent Application Publication
(10) Pub. No.: US 2012/0004972 A1
(43) Pub. Date: Jan. 5, 2012

(54) SYSTEM AND METHOD FOR INTEGRATING NEAR FIELD COMMUNICATION DEVICES WITH LEGACY CUSTOMER LOYALTY SERVICES

(75) Inventors: Michael S. Wengrovitz, Concord, MA (US); Brian Stout, Colorado Springs, CO (US)

(73) Assignee: ALCATEL-LUCENT USA INC., Murray Hill, NJ (US)

(21) Appl. No.: 12/828,203

(22) Filed: Jun. 30, 2010

(51) Int. Cl. G06Q 30/00; G06Q 20/00; G06K 7/10

(52) U.S. Cl. 705/14.27; 235/380; 705/17

(57) ABSTRACT

A tag correlation server enables customer loyalty services to be provided to consumers using near field communication (NFC) devices. The tag correlation server receives a tag ID of an NFC tag fixed to a mobile device of a consumer from a point-of-sale device of a business as part of a transaction between the consumer and the business. The tag correlation server identifies a loyalty card ID of the consumer for the business based on the tag ID and provides the loyalty card ID to a loyalty server of the business to determine loyalty information for the consumer to complete the transaction.

### BACKGROUND OF THE INVENTION

1. Technical Field of the Invention

The present invention relates in general to communication systems and in particular, to near field communication devices and services.

2. Description of Related Art

Many businesses, such as restaurants, grocery stores, shops and other retail establishments, enable customers to sign-up for and receive loyalty cards that can be used to make purchases or receive discounts. For example, if the loyalty card provides access to a stored value account (SVA), the customer can add value to the card by transferring the desired amount from a credit card or providing other form of payment, either in person at the cash register or online via the web. The transferred value is not usually stored within the card itself, but rather within a database in the establishment's back office loyalty server.

Loyalty cards are convenient and useful for customers since consumers can pre-pay for goods and receive special discounts and other benefits. Loyalty cards are also convenient and useful for businesses since businesses can invest the prepaid funds and need not pay a per-transaction fee to a credit card company for each purchase. In addition, loyalty cards enable businesses to discount merchandise that may be overstocked and also provide businesses with the tools to track customer purchases.

Typically, a customer receives a plastic card containing a magnetic stripe with a specific loyalty card identifier (ID). When using a loyalty card to make a purchase, the card ID on the card's magnetic stripe is read by a magnetic stripe reader attached to a point-of-sale appliance, such as a cash register. The card ID and transaction information, such as the total transaction amount, items purchased and individual prices, store location and other relevant information, are transmitted to the loyalty server. The loyalty server uses the card ID to access the customer's loyalty account and retrieve customer information. Based on the transaction information and customer information, the loyalty server determines loyalty information related to the transaction and provides the loyalty information back to the point-of-sale.

For example, if the loyalty card is used to provide discounts on merchandise, the loyalty information can include the discounted price for each discounted item purchased by the customer. As another example, if the loyalty card is used to provide access to the customer's SVA, the loyalty server determines whether there are funds in the customer's account, and if so, debits the account the amount of the transaction up to the maximum amount in the SVA (if authorized by the user/customer). The loyalty information provided back to the point-of-sale appliance then includes an authorization for the purchase and any remaining balance in the customer's account or any remaining amount owed by the customer.

Recently, some retail establishments have started using smart phones within their loyalty-card process. In the near-future, consumers may no longer need to carry cash, credit cards, or wallets containing plastic pre-paid loyalty cards and instead will just carry their mobile phones to make purchases.

For example, current smart phone loyalty systems enable a customer who has previously registered for and obtained a plastic loyalty card to download an application on his/her smart phone. The application typically includes a 2D barcode that can be read by a 2D barcode reader connected to a point-of-sale appliance of the business. At the time of purchase, the customer can present either his/her plastic card or smart phone to receive loyalty services. If the plastic loyalty card is presented, the magnetic stripe reader transmits the customer's card ID via the point-of-sale to the loyalty server, or if the smart phone application is presented, the 2D barcode reader transmits the customer's card ID via the point-of-sale to the loyalty server.

Recently, another type of identification technology, referred to as RFID (Radio Frequency Identification) or NFC (Near-Field Communication), has been proposed for use with smart phones. For example, an RFID/NFC tag can be placed on the back of a mobile phone, while the RFID/NFC reader is stationary and attached, for example, to a cash register. The stationary RFID/NFC reader receives a tag ID from the RFID/NFC tag and transmits the tag ID and its reader ID to a system for processing of the tag ID and reader ID.

However, typically RFID/NFC tags contain only a single tag ID, which differs from the loyalty card ID, and it is not easy or convenient to write and store the loyalty card ID within an RFID tag. Furthermore, the process becomes much more cumbersome when the user is registered for multiple loyalty services. For example, if the user has a different loyalty card for a coffee shop, a donut shop and a grocery store, the RFID/NFC tag would need to be written with all three loyalty card ID's, which is an inefficient process and increases the processing necessary at the legacy loyalty server to distinguish between the card ID's on the RFID/NFC tag. Therefore, what is needed is an efficient process for converting the RFID tag ID to the specific customer loyalty card ID for each legacy loyalty service.

### SUMMARY OF THE INVENTION

A tag correlation server, in one embodiment of the present invention, enables customer loyalty services to be provided to consumers using near field communication (NFC) devices. The tag correlation server includes an interface for receiving a tag ID of an NFC tag fixed to a mobile device of a consumer from a point-of-sale device of a business as part of a transaction between the consumer and the business. The tag correlation server further includes a processor that identifies a loyalty card ID of the consumer for the business based on the tag ID and provides the loyalty card ID to a loyalty server of the business to determine loyalty information for the consumer to complete the transaction.

In one embodiment, the interface is further coupled to receive a reader ID of an NFC reader in communication with the NFC tag and the processor further operable to identify the loyalty server based on the reader ID. In a further embodiment, the interface receives the tag ID and an additional reader ID of an additional NFC reader in communication with the NFC tag from an additional point-of-sale device of an additional business as part of an additional transaction between the consumer and the additional business and the processor is further operable to identify an additional loyalty card ID from the tag ID and an additional loyalty server associated with the additional business based on the reader ID and to provide the additional loyalty card ID to the additional loyalty server to complete the additional transaction.

In yet another embodiment, the processor is further operable to identify an additional loyalty card ID associated with an additional loyalty server of an additional business based on the tag ID and the reader ID and to provide the additional loyalty card ID to the additional loyalty server to determine additional loyalty information for the consumer. In still another embodiment, the interface is further operable to receive transaction information related to the transaction and to provide the transaction information to the loyalty server to determine the loyalty information.

A system, in another embodiment of the invention, includes a near field communication (NFC) reader of a business for wirelessly communicating with an NFC tag fixed to a mobile device of the consumer to receive a tag ID of the NFC tag as part of a transaction between the consumer and the business. The system further includes a point-of-sale device of the business coupled to the NFC reader to receive the tag ID of the consumer, a tag correlation server for receiving the tag ID from the point-of-sale device and identifying a loyalty card ID of the consumer for the business based on the tag ID and a loyalty server of the business for receiving the loyalty card ID from the tag correlation server and determining loyalty information for the consumer based on the loyalty card ID. The loyalty server further provides the loyalty information to the point-of-sale device to complete the transaction.

In yet another embodiment of the invention, a method provides customer loyalty services to a consumer. The method includes receiving a tag ID of a near field communication (NFC) tag fixed to a mobile device of a consumer from a point-of-sale device of a business as part of a transaction between the consumer and the business. The method further includes identifying a loyalty card ID of the consumer for the business based on the tag ID and providing the loyalty card ID to a loyalty server of the business to determine loyalty information for the consumer to complete the transaction.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary loyalty system, in accordance with embodiments of the present invention;

FIG. 2 is a block diagram of exemplary tag correlation server for use within the loyalty system, in accordance with embodiments of the present invention;

FIG. 3 is a flowchart illustrating an exemplary process for providing customer loyalty services to a consumer, in accordance with embodiments of the present invention;

FIG. 4 illustrates an exemplary signal flow diagram, in accordance with embodiments of the present invention;

FIG. 5A illustrates yet another exemplary loyalty system, in accordance with embodiments of the present invention;

FIG. 5B illustrates another exemplary signal flow diagram, in accordance with embodiments of the present invention;

FIG. 6 illustrates yet another exemplary loyalty system, in accordance with embodiments of the present invention; and

FIG. 7 illustrates still another exemplary loyalty system, in accordance with embodiments of the present invention.

### DETAILED DESCRIPTION OF THE DRAWINGS

In accordance with embodiments of the present invention, a loyalty system is provided in which a near-field communication device (NFC) is fixed to a mobile device or smart phone of a consumer. The loyalty system efficiently integrates existing mobile devices and legacy loyalty servers in order to avoid provide a more convenient loyalty service to customers and businesses, thereby minimizing cost and providing a practical solution.

FIG. 1 illustrates an exemplary loyalty system 10, in accordance with embodiments of the present invention. The loyalty system 10 includes a legacy loyalty server 90 of a particular business maintaining customer loyalty accounts. The loyalty server 90 can include the loyalty accounts of a single business location or multiple locations. The loyalty system 10 further includes at least one point-of-sale (POS) appliance, such as a cash register 50, coupled to the loyalty server 90 via a local area network (LAN) 60 or other Internet Protocol (IP) network of the business.

In addition, the loyalty system 10 also includes a near field communication (NFC) reader 40 coupled to the POS 50. As used herein, the term “NFC” refers to a short-range, high frequency wireless communication technology that enables the exchange of data between devices over about a small distance, such as a few centimeters. NFC communicates via magnetic field induction, where two loop antennas are located within each other's near field, effectively forming an air-core transformer, and typically operates within the 125 kHz frequency band and/or the 13.56 MHz frequency band.

The NFC reader 40 is operable to wirelessly communicate with an NFC tag 30 fixed to a mobile device 20 of a customer of the business. The NFC tag 30 stores identification data for use in identifying the customer, while the NFC reader 40 operates as an interrogator to retrieve the identification data stored on the NFC tag 30. The NFC tag 30 may be an active tag that includes an internal power source, such as a battery, and/or a passive tag that does not contain an internal power source, but instead is remotely powered by the NFC reader.

As described above, communication between the NFC reader and the NFC tag is enabled by radio frequency (RF) signals. In general, to access the identification data stored on an NFC tag 30, the NFC reader 40 generates a modulated RF interrogation signal designed to evoke a modulated RF response from a tag. The RF response from the tag includes the coded identification data stored in the NFC tag 30. The NFC reader 40 decodes the coded identification data to identify the person/user associated with the NFC tag 30. For passive tags, the NFC reader 40 also generates a signal to activate and power the tag 30 during data transfer.

In accordance with embodiments of the present invention, to translate the tag ID of the user into a loyalty card ID of the business, a Tag Correlation Server (TCS) 70 is deployed on the LAN 60 in between the suite of cash registers 50 (only one of which is shown for simplicity) for the business chain and the legacy loyalty server 90. The TCS 70 converts between the tag ID stored within the NFC tag 30 and the loyalty card ID required by the legacy loyalty server 90. The TCS 70 uses a database 80, which may be internal or external, to lookup the loyalty card ID as a function of the tag ID. In some embodiments, as described in more detail below, the TCS 70 also uses the reader ID in addition to the tag ID to derive the loyalty card ID, thereby allowing a single RFID/NFC tag 30 to be used with multiple different loyalty services provided by multiple businesses or multiple loyalty servers of a single business.

In an exemplary embodiment, when a consumer places the mobile device 20 in close proximity with the NFC reader 40 of the business during a transaction between the consumer and the business, the NFC reader 40 communicates with the NFC tag 30 to retrieve the identification data (i.e., tag ID) that identifies the consumer associated with the NFC tag 30. The NFC reader 40 then provides the tag ID, and the reader ID of the NFC reader 40, to the POS 50. The POS 50 then forwards the tag ID to the TCS 70 via the LAN 60. The TCS 70 uses the tag ID to access the TC database 80 to lookup the card ID of the business associated with the tag ID and forwards the card ID to the loyalty server 90.

In addition to the tag ID, the POS 50 may also forward transaction information to the TCS 70, which then forwards the transaction information, along with the loyalty card ID to the loyalty server 90. The transaction information can include, for example, the total transaction amount, items purchased and individual prices, store location and other relevant information. The loyalty server 90 uses the card ID to access the customer's loyalty account and retrieve customer information. The customer information may indicate, for example, particular discounts available to the customer or an account balance of the customer's stored value account (SVA).

Based on the transaction information and customer information, the loyalty server 90 determines loyalty information related to the transaction and provides the loyalty information back to the POS 50. For example, the loyalty information can include the discounted price for each discounted item purchased by the consumer, as determined from the transaction information and/or the customer information. As another example, the loyalty information can indicate whether or not the customer has sufficient funds in the customer's account to cover the cost of the transaction and any remaining balance in the customer's account. The POS 50 applies the discounts or customer funds to the purchase to complete the transaction with the consumer.

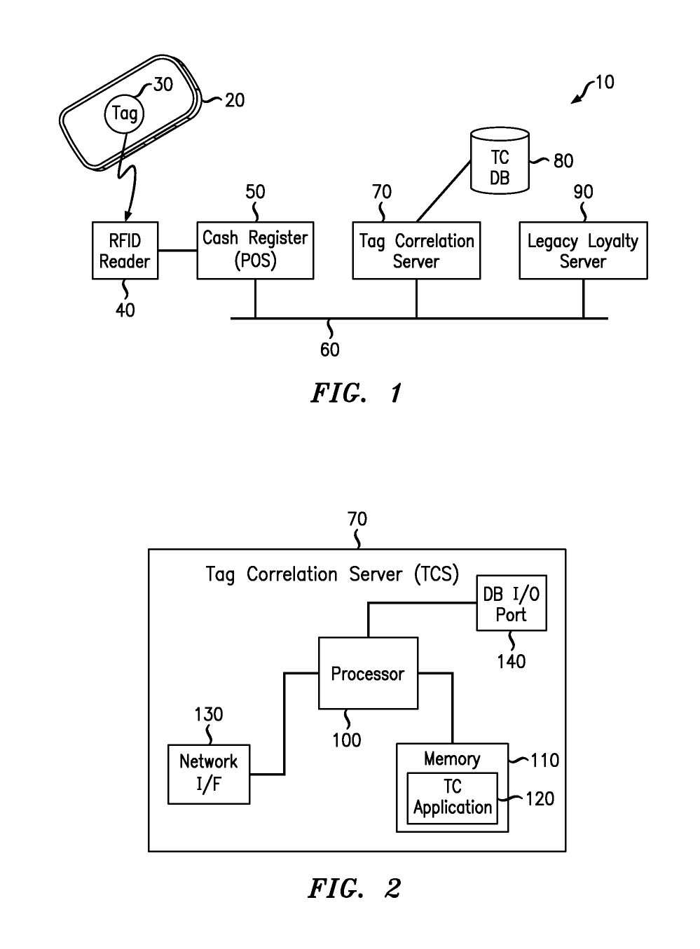

FIG. 2 is a block diagram of an exemplary TCS 70, in accordance with embodiments of the present invention. The TCS 70 includes a processor 100, memory 110, network interface (I/F) 130 and I/O 140. The network interface 130 is coupled to a local area network (LAN) of the business or other type of communication network, while the I/O 140 is coupled to the TC database. However, in some embodiments, the TC database is implemented within the TCS 70, and therefore, the I/O 140 is not necessary.

The memory 110 maintains a tag correlation (TC) application 120, and the processor 100 is further coupled to the memory 110 to execute instructions of the TC application 120. For example, the processor 100 can execute instructions of the TC application 120 to receive a tag ID, and in some embodiments, a reader ID from a POS of a business via network I/F 130. The processor 100 can further execute instructions of the TC application 120 to provide the tag ID to the TC database and receive a corresponding loyalty card ID from the TC database via I/O 140.

In embodiments in which the TCS 70 provides tag conversion services for multiple businesses or a single business that includes multiple loyalty servers, the TC application 120 further provides the received reader ID, which identifies a particular POS of a particular business, to the TC database via the I/O 140. In this embodiment, in addition to the loyalty card ID, the TC database can also provide an identity (network address, IP address or other identifier) of a loyalty server associated with the reader ID.

The processor 100 can further execute instructions of the TC application 120 to provide the loyalty card ID to the identified loyalty server of the business. In embodiments in which the TCS 70 further receives transaction information related to a transaction between a consumer associated with the tag ID and the business via network I/F 130, the processor 100 can further execute instructions of the TC application 120 to forward the transaction information with the loyalty card ID to the loyalty server.

As used herein, the term “processor” is generally understood to be a device that drives a general-purpose computer, such as a PC. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein. In addition, as used herein, the term “memory” includes any type of data storage device, including but not limited to, a hard drive, random access memory (RAM), read only memory (ROM), flash memory or other type of storage device or storage medium.

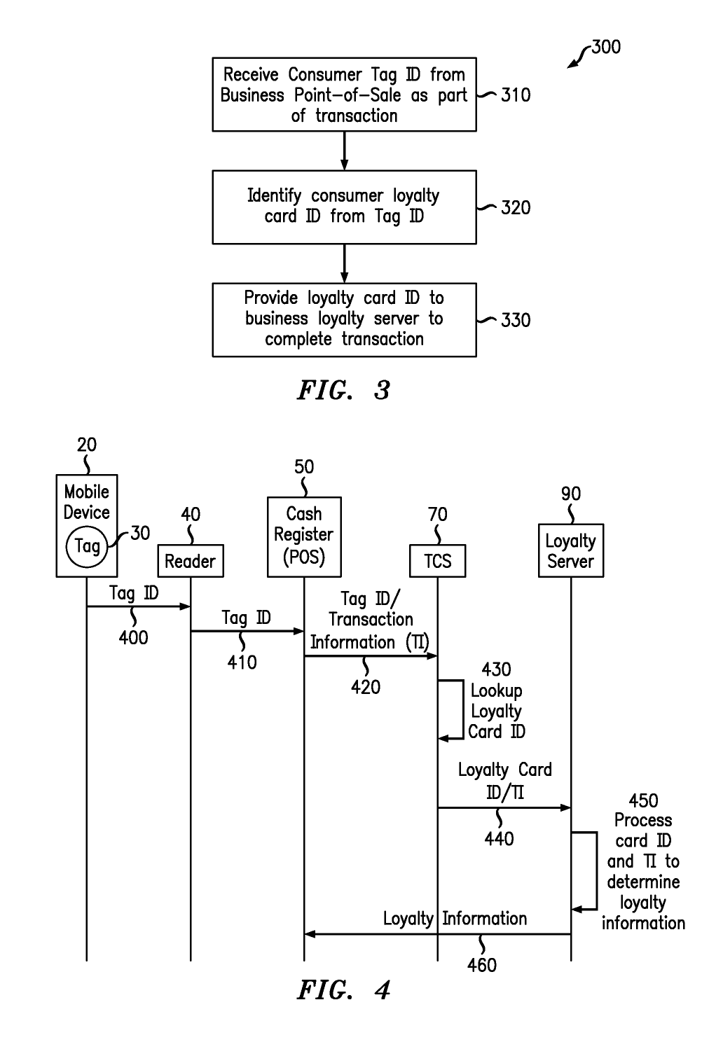

FIG. 3 is a flowchart illustrating an exemplary process 300 for providing customer loyalty services to a consumer, in accordance with embodiments of the present invention. The process begins at block 310, where a tag ID of a near field communication (NFC) tag fixed to a mobile device of a consumer is received from a point-of-sale device of a business as part of a transaction between the consumer and the business. At block 320, a loyalty card ID of the consumer for the business is identified based on the tag ID. The process ends at block 330, where the loyalty card ID is provided to a loyalty server of the business to determine loyalty information for the consumer to complete the transaction.

FIG. 4 illustrates an exemplary signal flow diagram, in accordance with embodiments of the present invention. In FIG. 4, the TCS 70 is coupled to the LAN (IP network) to act as a “man-in-the-middle” element. Thus, in FIG. 4, at 400, when an NFC tag 30 of a consumer that is fixed to a mobile device operated by the user/customer comes into close proximity with an NFC reader 40 operated by a business during a transaction between the consumer and the business, the NFC reader 40 obtains the tag ID identifying the user/customer from the NFC tag 30. Thereafter, at 410, the NFC reader 40 transmits the tag ID to a cash register or other POS 50 of the business conducting the transaction.

At 420, the POS 50 provides the tag ID and any transaction information (TI), such as items purchased, prices of items purchased, total cost of transaction, store ID and other information, to the TCS 70. At 430, the TCS uses the tag ID to lookup the loyalty card ID of the consumer for the business and at 440, provides the loyalty card ID and any received transaction information to the loyalty server 90 of the business. Once the card ID and transaction information is received by the legacy loyalty server 90, at 450, the loyalty server 90 processes the card ID and transaction information to determine loyalty information for the transaction. For example, the loyalty information can include discounts or funds to be applied to the transaction. Thereafter, at 460, the loyalty information is transmitted from the loyalty server 90 back to the POS 50 to complete the transaction.

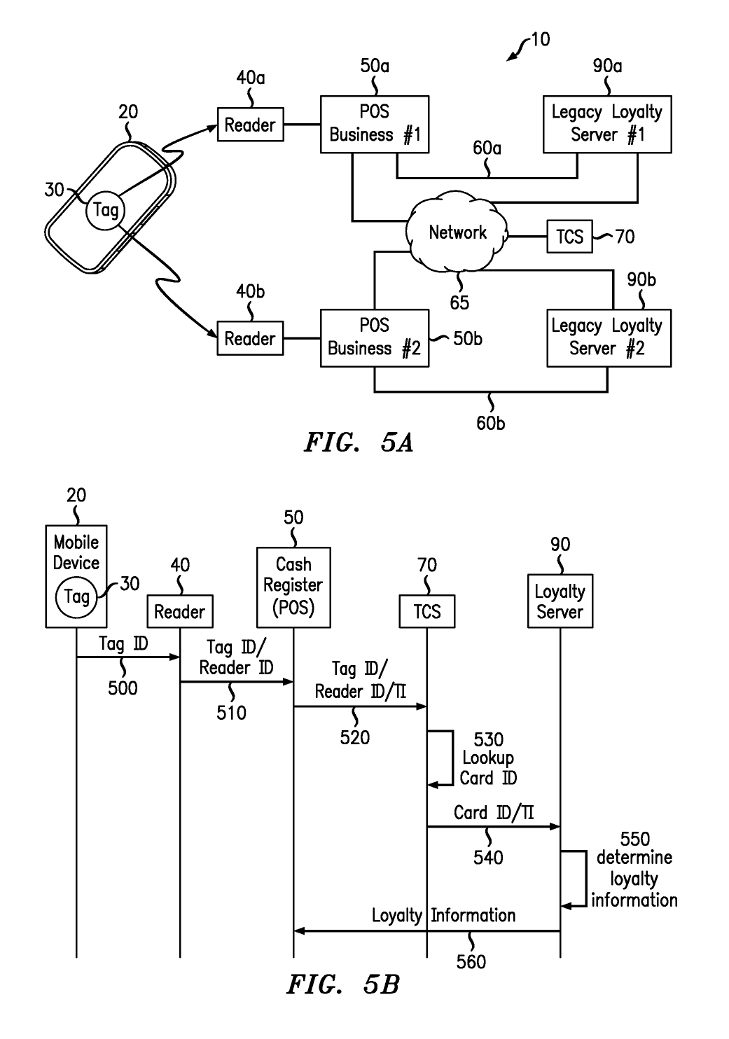

FIG. 5A illustrates yet another exemplary loyalty system, in accordance with embodiments of the present invention. In FIG. 5A, the TCS 70 is further coupled to a communication network 65, such as a packet-switched network, to provide tag correlation services to multiple businesses. For example, the communication network 65 may include, but is not limited to, one or more of an Internet Protocol (IP), Multiprotocol Label Switching (MPLS), Asynchronous Transfer Mode (ATM), Ethernet or other packet-switched wired or wireless network. In this embodiment, a consumer only needs to have a single NFC tag 30 with a single tag ID to utilize the loyalty services provided by multiple places of business.

Thus, as can be seen in FIG. 5A, the TCS 70 can couple between a first POS 50a and a first loyalty server 90a of a first business and between a second POS 50b and a second loyalty server 90b of a second business. To determine the appropriate loyalty card ID for a particular transaction, the TCS 70 receives both the tag ID and the reader ID from a POS 50a or 50b. The TCS 70 also uses the reader ID to determine the appropriate loyalty server 90a or 90b for the transaction.

In an exemplary operation, when a consumer places the mobile device 20 in close proximity with the NFC reader 40a of the first business during a transaction between the customer and the first business, the NFC reader 40a communicates with the NFC tag 30 to retrieve the identification data (i.e., tag ID) that identifies the consumer associated with the NFC tag 30. The NFC reader 40a then provides the tag ID and the reader ID of the NFC reader 40a to the POS 50a of the first business. The POS 50a then forwards the tag ID and reader ID, along with transaction information, to the TCS 70 via the communication network 65. The TCS 70 uses the tag ID and reader ID to lookup the loyalty card ID for the consumer of the first business and identify the loyalty server 90a (i.e., a network address or other identifier) for the first business. The TCS 70 then forwards the loyalty card ID and transaction information to the loyalty server 90a via the communication network 65. Based on the transaction information and customer information, the loyalty server 90a determines loyalty information related to the transaction and provides the loyalty information back to the POS 50a via the LAN 60a of the first business.

In another exemplary operation, when the consumer places the mobile device 20 in close proximity with the NFC reader 40b of the second business during a previous or subsequent transaction between the consumer and the second business, the NFC reader 40b communicates with the NFC tag 30 to retrieve the tag ID of the NFC tag 30. The NFC reader 40b then provides the tag ID and the reader ID of the NFC reader 40b to the POS 50b of the second business. The POS 50b then forwards the tag ID and reader ID, along with transaction information, to the TCS 70 via the communication network 65. The TCS 70 uses the tag ID and reader ID to lookup the loyalty card ID for the consumer of the second business and identify the loyalty server 90b (i.e., a network address or other identifier) for the second business. The TCS 70 then forwards the loyalty card ID and transaction information to the loyalty server 90b via the communication network 65. Based on the transaction information and customer information, the loyalty server 90b determines loyalty information related to the transaction and provides the loyalty information back to the POS 50b via the LAN 60b of the second business.

FIG. 5B illustrates another exemplary signal flow diagram, in accordance with embodiments of the present invention. In FIG. 5B, the TCS 70 is coupled to a communication network to perform tag conversion services for multiple businesses. Thus, in FIG. 5B, at 500, when an NFC tag 30 of a consumer that is fixed to a mobile device operated by the consumer comes into close proximity with an NFC reader 40 operated by a business during a transaction between the consumer and the business, the NFC reader 40 obtains the tag ID identifying the consumer from the NFC tag 30. Thereafter, at 510, the NFC reader 40 transmits the tag ID and the reader ID to a cash register or other POS 50 of the business conducting the transaction.

At 520, the POS 50 provides the tag ID, reader ID and any transaction information (TI) to the TCS 70. At 530, the TCS uses the tag ID and reader ID to lookup the loyalty card ID of the consumer for the business and identify the particular loyalty server for the business and at 540, provides the loyalty card ID and any received transaction information to the loyalty server 90 of the business. Once the card ID and transaction information is received by the legacy loyalty server 90, at 550, the loyalty server 90 processes the card ID and transaction information to determine loyalty information for the transaction. Thereafter, at 560, the loyalty information is transmitted from the loyalty server 90 back to the POS 50 to complete the transaction.

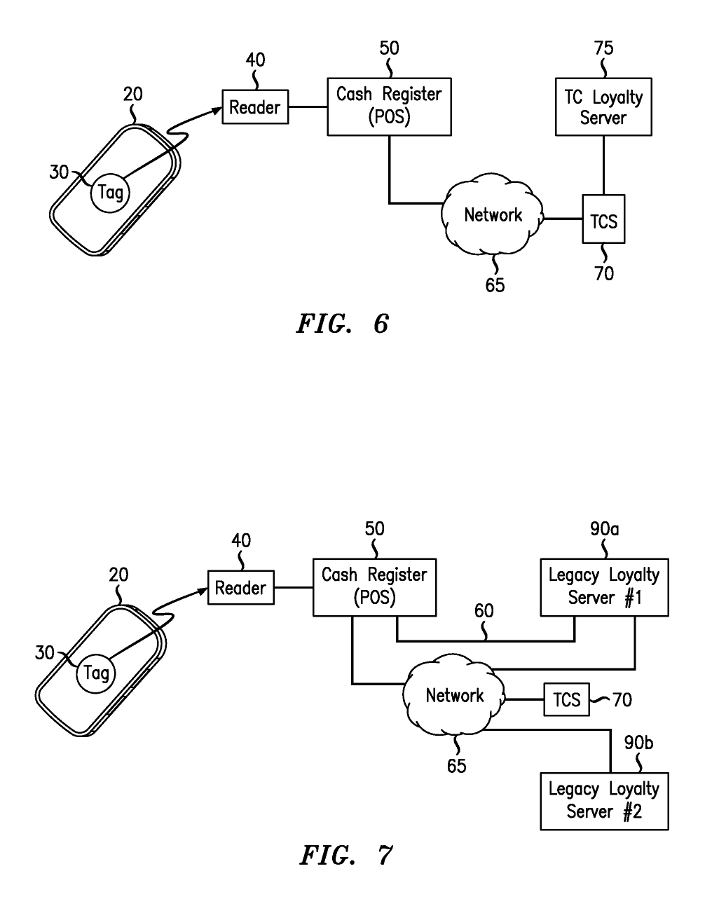

FIG. 6 illustrates yet another exemplary loyalty system, in accordance with embodiments of the present invention. In FIG. 6, the TCS 70 is coupled to its own multi-tenant loyalty server 75, thereby enabling businesses that do not have an existing loyalty infrastructure to begin providing loyalty services. In this manner, a single NFC-enabled mobile phone can be used as an electronic wallet having access to multiple legacy and non-legacy loyalty services.

In an exemplary operation, when a consumer places the mobile device 20 in close proximity with the NFC reader 40 of a non-legacy loyalty business during a transaction between the consumer and the business, the NFC reader 40 communicates with the NFC tag 30 to retrieve the tag ID associated with the NFC tag 30. The NFC reader 40 then provides the tag ID and the reader ID of the NFC reader 40 to the POS 50 of the business. The POS 50 then forwards the tag ID and reader ID, along with transaction information, to the TCS 70 via the communication network 65. The TCS 70 uses the tag ID and reader ID to lookup the loyalty card ID for the consumer/customer of the business and to identify the TC loyalty server 75 as the loyalty server for the business. The TCS 70 then forwards the loyalty card ID and transaction information to the TC loyalty server 75. Based on the transaction information and customer information, the TC loyalty server 75 determines loyalty information related to the transaction and provides the loyalty information back to the POS 50 via the TCS 70 and communication network 65.

FIG. 7 illustrates still another exemplary loyalty system, in accordance with embodiments of the present invention. In FIG. 7, the TCS 70 supports multiple loyalty services for a single transaction. For example, if a business provides different types of loyalty services (i.e., discounts and stored value accounts), each being managed by a different physical loyalty server 90a and 90b, and each potentially having a different loyalty card ID for the consumer associated therewith, the TCS 70 can identify all loyalty servers 90a and 90b for the business applicable to a particular transaction and forward the appropriate card ID and transaction information to the loyalty servers 90a and 90b. As another example, if two or more businesses have partnered to provide different loyalty services based on a transaction conducted at one of the businesses, the TCS 70 can identify all loyalty servers 90a and 90b and associated loyalty card ID's applicable to a particular transaction and forward the respective card ID's and transaction information to the identified loyalty servers 90a and 90b.

In an exemplary operation involving two different businesses, as shown in FIG. 7, when a consumer places the mobile device 20 in close proximity with the NFC reader 40 of a first business during a transaction between the consumer and the first business, the NFC reader 40 communicates with the NFC tag 30 to retrieve the tag ID associated with the NFC tag 30. The NFC reader 40 then provides the tag ID and the reader ID of the NFC reader 40 to the POS 50 of the first business. The POS 50 then forwards the tag ID and reader ID, along with transaction information, to the TCS 70 via the communication network 65.

The TCS 70 uses the tag ID and reader ID to lookup the loyalty card ID for the consumer of the first business and to identify the loyalty server 90a for the first business. The TCS 70 then forwards the loyalty card ID and transaction information to the loyalty server 90a of the first business via communication network 65. Based on the transaction information and customer information, the loyalty server 90a of the first business determines loyalty information related to the transaction and provides the loyalty information back to the POS 50 via the LAN 60 of the first business.

In addition, the TCS 70 further identifies a loyalty card ID and loyalty server 90b of a second business that is partnered with the first business from at least one of the tag ID and the reader ID. The TCS 70 may also process the transaction information to determine whether the card ID of the second business should be sent to the loyalty server 90b. For example, a consumer may receive a certain number of advantage miles on a particular airline for purchasing a particular product at another business. Once the TCS 70 has identified the loyalty card ID and loyalty server of the second business, the TCS 70 forwards the loyalty card ID, and in some embodiments, at least part of the transaction information, to the loyalty server 90b of the second business via communication network 65 for application of loyalty services by the second business to the user/customer.

In one embodiment, the loyalty services provided by the second business include discounts or funds applicable to the transaction. In this embodiment, the loyalty server 90b of the second business communicates with the POS 50 via the TCS 70 and communication network 65 and/or the loyalty server 90a of the first business to provide the discounts or funds. For example, a first business may allow a customer to use funds in a stored value account of another business to pay for transactions conducted at the first business. As another example, a first business may honor or match coupons or other discounts offered by a second business.

As will be recognized by those skilled in the art, the innovative concepts described in the present application can be modified and varied over a wide range of applications. Accordingly, the scope of patents subject matter should not be limited to any of the specific exemplary teachings discussed, but is instead defined by the following claims.

1. A tag correlation server, comprising:
an interface coupled to a network to receive a tag ID of a near field communication (NFC) tag fixed to a mobile device of a consumer from a point-of-sale device of a business as part of a transaction between the consumer and the business;
a processor coupled to the interface to receive the tag ID and operable to identify a loyalty card ID of the consumer for the business based on the tag ID and to provide the loyalty card ID to a loyalty server of the business to determine loyalty information for the consumer to complete the transaction.

2. The tag correlation server of claim 1, wherein the interface is coupled to a local area network of the business to receive the tag ID and to provide the loyalty card ID to the loyalty server.

3. The tag correlation server of claim 1, wherein the interface is further coupled to receive a reader ID of an NFC reader in communication with the NFC tag, the processor further operable to identify the loyalty server based on the reader ID.

4. The tag correlation server of claim 3, wherein the interface is coupled to an external communication network to receive the tag ID from the point-of-sale device and to provide the loyalty card ID to the loyalty server.

5. The tag correlation server of claim 3, wherein:
the interface further receives the tag ID and an additional reader ID of an additional NFC reader in communication with the NFC tag from an additional point-of-sale device of an additional business as part of an additional transaction between the consumer and the additional business; and
the processor is further operable to identify an additional loyalty card ID from the tag ID and an additional loyalty server associated with the additional business based on the reader ID and to provide the additional loyalty card ID to the additional loyalty server to complete the additional transaction.

6. The tag correlation server of claim 3, wherein the processor is further operable to identify an additional loyalty card ID associated with an additional loyalty server of an additional business based on the tag ID and the reader ID and to provide the additional loyalty card ID to the additional loyalty server to determine additional loyalty information for the consumer.

7. The tag correlation server of claim 1, wherein the interface is further operable to receive transaction information related to the transaction and to provide the transaction information to the loyalty server to determine the loyalty information.

8. A system for providing customer loyalty services to a consumer, the system comprising:
a near field communication (NFC) reader of a business for wirelessly communicating with an NFC tag fixed to a mobile device of the consumer to receive a tag ID of the NFC tag as part of a transaction between the consumer and the business;
a point-of-sale device of the business coupled to the NFC reader to receive the tag ID of the consumer;
a tag correlation server for receiving the tag ID from the point-of-sale device and operable to identify a loyalty card ID of the consumer for the business based on the tag ID; and
a loyalty server for the business for receiving the loyalty card ID from the tag correlation server and operable to determine loyalty information for the consumer based on the loyalty card ID and to provide the loyalty information to the point-of-sale device to complete the transaction.

9. The system of claim 8, further comprising:
a local area network of the business coupled to the point-of-sale device, the tag correlation server and the loyalty server.

10. The system of claim 8, wherein:
the point-of-sale device is further coupled to receive a reader ID of the NFC reader and to provide the reader ID to the tag correlation server; and
the tag correlation server is further operable to identify the loyalty server based on the reader ID.

11. The system of claim 10, further comprising:
an external communication network for coupling the tag correlation server to multiple point-of-sale devices and multiple loyalty servers of multiple businesses.

12. The system of claim 10, wherein the tag correlation server is further operable to identify an additional loyalty card ID associated with an additional loyalty server of an additional business based on the tag ID and the reader ID and to provide the additional loyalty card ID to the additional loyalty server to determine additional loyalty information for the consumer.

13. The system of claim 8, wherein the tag correlation server is further operable to receive transaction information related to the transaction from the point-of-sale device and to provide the transaction information to the loyalty server to determine the loyalty information.

14. The system of claim 8, wherein the loyalty server is operable to determine loyalty information for a plurality of businesses.

15. The system of claim 8, wherein the loyalty information includes a value-added service for the consumer.

16. A method for providing customer loyalty services to a consumer, the method comprising:
receiving a tag ID of a near field communication (NFC) tag fixed to a mobile device of a consumer from a point-of-sale device of a business as part of a transaction between the consumer and the business;
identifying a loyalty card ID of the consumer for the business based on the tag ID; and
providing the loyalty card ID to a loyalty server of the business to determine loyalty information for the consumer to complete the transaction.

17. The method of claim 16, wherein the receiving further includes receiving a reader ID of an NFC reader in communication with the NFC tag, and further comprising:
identifying the loyalty server based on the reader ID.

18. The method of claim 16, further comprising:
identifying an additional loyalty card ID associated with an additional loyalty server of an additional business based on the tag ID and the reader ID; and
providing the additional loyalty card ID to the additional loyalty server to determine additional loyalty information for the consumer.

19. The method of claim 16, further comprising:
receiving transaction information related to the transaction; and
providing the transaction information to the loyalty server to determine the loyalty information.

20. The method of claim 16, further comprising:
repeating the steps of receiving, identifying and providing for multiple businesses.
